(19) United States
(12) Patent Application Publication
(10) Pub. No.: US 2003/0014078 A1
(43) Pub. Date: Jan. 16, 2003

(54) Baby teething pacifier apparatus and method

(76) Inventor: Tiffani A. Robbins, Shelton, WA (US)

Correspondence Address: WILLIAM G. FORSTER, LAW OFFICES, WILLIAM G. FORSTER, P.O. BOX 577, SUMNER, WA, 98390, US

(21) Appl. No.: 10/193,034

(22) Filed: Jul. 10, 2002

Related U.S. Application Data
(60) Provisional application No. 60/304,470, filed on Jul. 10, 2001.

(51) Int. Cl. A61J 17/00

(52) U.S. Cl. 606/235

(57) ABSTRACT

A teething pacifier constructed for receiving a volume of flavored frozen liquid which melts while therein to transmit a resulting cold melted liquid to an infant's mouth and gums while the infant is sucking on the same. The teething pacifier comprises a first sidewall constructed of a porous, permeable material such as terry cloth. The first side-wall is typically rectangular in shape, and defines a perimeter edge. A second sidewall, of like shape, is constructed of a porous material to define a perimeter edge. The second sidewall forms a mirror image of the first sidewall so that the first and second sidewalls can be aligned adjacently and sewn together along their respective perimeter edges to form a containment compartment disposed between the first and second sidewalls. The containment compartment defines an opening for receiving the frozen liquid therein. Means for closing or restricting the opening is provided for maintaining the frozen liquid within the containment compartment. A band is connected to at least one sidewall for tethering the containment compartment to an infant's arm.

This application claims the benefit of U.S. Provisional Application No. 60/304,470 filed Jul. 10, 2001.

### BACKGROUND

This invention relates generally to pacifiers for infants and babies, and more particularly to pacifiers arranged to deliver chilled liquid to an infant's mouth and gums for medicinal and soothing purposes.

Pacifiers for infants are well known and commonly available in a variety of designs. Some of the designs are directed to delivering liquids and or solids to the infant to help satisfy and calm the infant. For example, in 1975 U.S. Pat. No. 3,892,243 issued illustrating a pacifier constructed of a gauze impregnated with honey. Similarly, in 1993, U.S. Pat. No. 5,197,974 issued showing a nipple member that includes a fluid contained therein for chilling or heating prior to dispensing the same to an infant. This invention is complex in its construction and difficult to clean after use. Further, U.S. Pat. No. 5.364,348 issued in 1994 disclosing a feeding device having a food dispensing member of fine mesh material which food passes through to an infant's mouth. This device is constructed of three parts that require assembly prior to use which makes the same some what difficult to use and clean.

In addition, U.S. Pat. No. 5,658,314 issued in 1997 directed to a teething pacifier system that includes a freezable fluid with fluid runoff into an integral nipple or pacifier. The problem with this design is that it includes many parts and pouches that make it difficult to organize clean and store. Other designs include U.S. Design Pat. No. 402,760 directed to a pacifier with removable fabric; U.S. Pat. No. 5,908,440 directed to an infant teether comprising a hollow teething unit for holding hard teething foods such as cookies; U.S. Pat. No. 5,055,108 having liquid filled soft pouch attached to an upper partial dental device; and U.S. Pat. No. 5,682,838 illustrating a container for enclosing particulate matter for animals comprising hook and loop sealing construction. Each of these inventions, however fail to provide a simple means of delivering chilled liquid, in the form of a pacifier to an infant, in a slow, controlled, and safe manner.

Accordingly a need exists for an improved, safe and easily cleanable infant pacifier designed for use with readily available food products such as flavored frozen ice “pops”, to deliver the same as soothing chilled liquid to the gum of an infant.

### SUMMARY

One object of the present invention is to help soothe and calm an infant that is having pain due to the emergence of new teeth.

A second object is to pacify an infant so that the mother, parent or caregiver can more easily engage in other tasks.

Another object is to provide an inexpensive and safe method to dispense liquids and or frozen liquids to an infant.

Yet another object is to pacify an infant and divert the attention of the infant from whatever source of discomfort the infant is experiencing.

A further object is to provide a reusable sterile pacifier that is easily cleaned and sterilized.

Still another object is to employ common, readily available food products, including ice “pops” in pacifiers for infants.

The invention is a teething pacifier arranged for receiving a volume of flavored frozen liquid, i.e., flavored ice which melts while therein to transmit a resulting cold melted liquid to an infant's mouth and gums while the infant is sucking on the same. Specifically, the teething pacifier comprises a first sidewall constructed of a porous, permeable material such as terry cloth. The first side-wall is typically rectangular in shape, and defines a perimeter edge. Similarly, a second sidewall, of like shape, is constructed of a porous material to define a perimeter edge. Accordingly, the second sidewall forms a mirror image of the first sidewall. In this way, the first and second sidewalls can be aligned adjacently and sewn together along their respective perimeter edges to form a containment compartment disposed between the first and second sidewalls.

Importantly, the sewing is discontinuous, at one location, thereby forming an opening into the containment compartment for receiving the frozen liquid therein. To maintain the frozen liquid within the containment compartment, means for closing or restricting the opening is provided. Additionally, a band is connected to at least one sidewall for tethering the sidewalls and the containment compartment formed thereby to an infant's arm.

In another aspect of the invention, a closure fold is integrally formed with a sidewall to provide closure to the opening so that the frozen liquid is maintained within the containment compartment.

The foregoing and other objects, features, and advantages of this invention will become more readily apparent from the following detailed description of a preferred embodiment which proceeds with reference to the accompanying drawings, wherein the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIG. 1 is a side perspective view of an infant suckling a teething pacifier in accordance with the present invention.

FIG. 2 is a front perspective view of a teething pacifier having a integrally sewn snap-together wrist band.

FIG. 3 is a side view of a teething pacifier having an integrally sewn snap-together wrist band with the same being unsnapped.

FIG. 4 is an exploded view showing a frozen “freezer pop” being inserted into a teething pacifier constructed in accordance with the present invention.

FIG. 5 is a frontal perspective view illustrating a teething pacifier having a continuous, endless loop elastic wrist band connected to a pacifier “clip” device employed to positively connect the teething pacifier to clothing worn by the infant.

FIG. 6 is a plan view of a rectangular piece of permeable material for use in making a teething pacifier.

FIG. 7 is a plan view of a partially finished teething pacifier illustrating the step of folding the permeable material, and stitching the same to form a hem or edge, in preparation of making a teething pacifier in accordance with the present invention.

FIG. 8 is a plan view of a partially finished teething pacifier illustrating the step of attaching hook and loop strip material.

FIG. 9 is a plan view of a partially finished teething pacifier illustrating the step of attaching a wrist band.

FIG. 10 is a plan view of a partially finished teething pacifier illustrating the step of turning over the material in preparation of finishing the same to form a teething pacifier wherein a fold line is indicated for the step of folding as shown in FIG. 11.

FIG. 11 is a plan view of a partially finished teething pacifier illustrating the step of folding and sewing-together opposing edges of the same.

FIG. 12 is a plan view of a finished teething pacifier illustrating the step of turning inside-out the partially finished teething pacifier illustrated in FIG. 11 thereby hiding the stitches that join opposing edges of the teething pacifier.

FIG. 13 is a perspective view of an alternate embodiment teething pacifier illustrating a closure fold in the unclosed first position.

FIG. 14 is a partial perspective view of an alternate embodiment teething pacifier with portions removed to illustrate a closure fold with the arrow indicating the movement of the closure fold to an inside-out position which represents the second closed position.

FIG. 15 is a perspective view of an alternate embodiment teething pacifier illustrating a closure fold in the second closed position.

### DETAILED DESCRIPTION OF PREFERRED EMBODIMENT

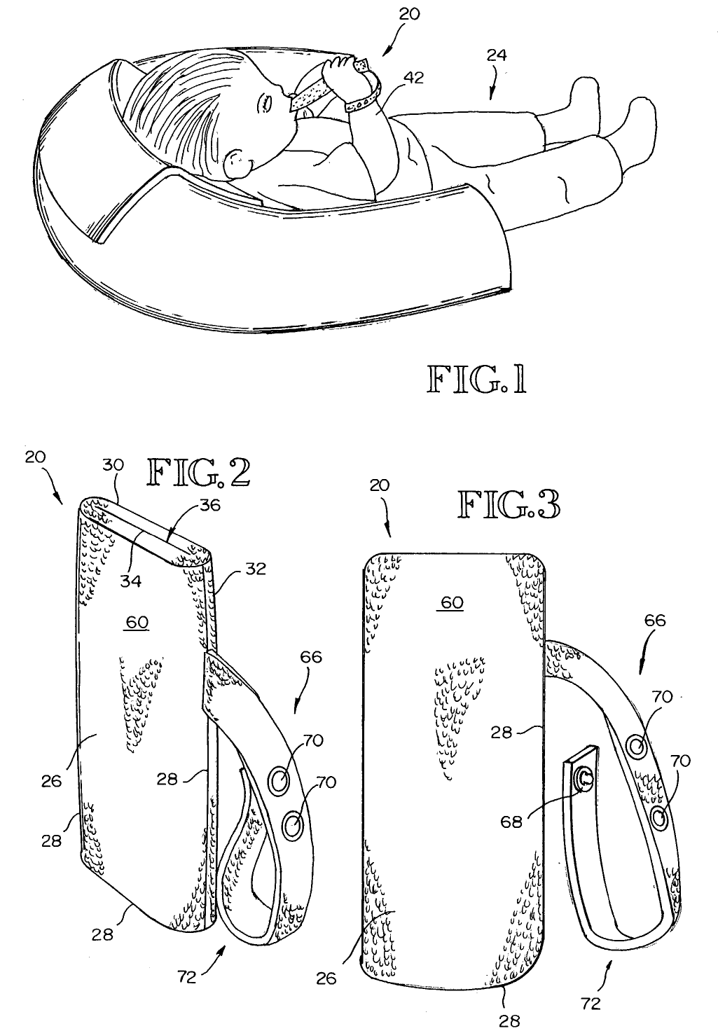

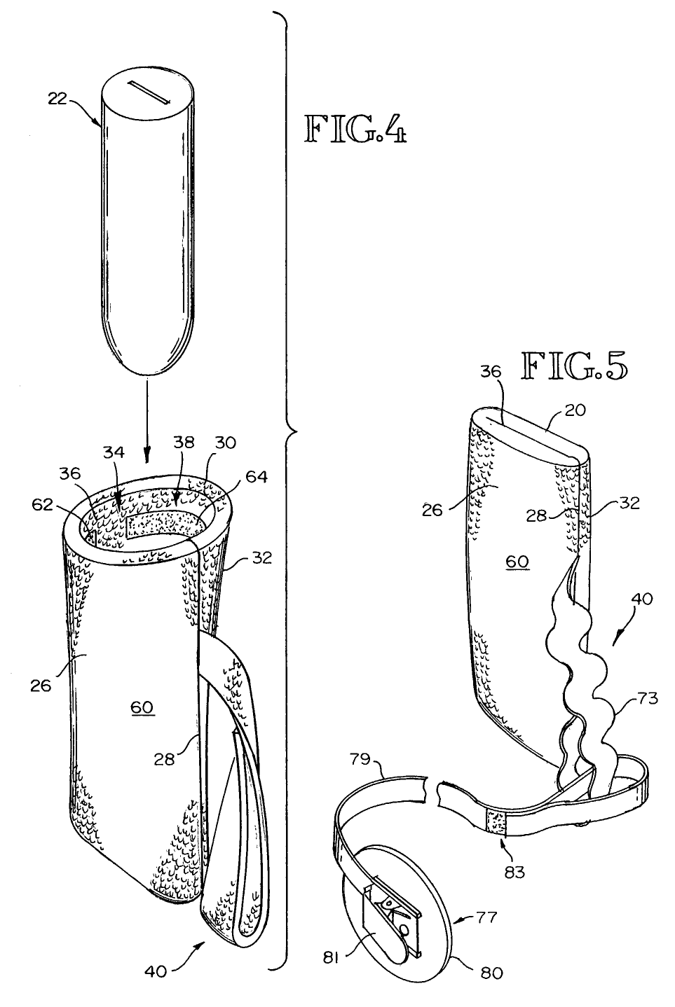

Referring now to the drawings, and first to FIGS. 1 through 5, shown generally at 20 is a teething pacifier arranged for receiving a volume of flavored frozen liquid 22 which melts while therein to transmit a resulting cold melted liquid to an infant's mouth and gums while the infant 24 is sucking on the same. It should be noted that any type of frozen liquid could be employed within the present invention, however a “freezer pop” brand type of frozen liquid, without a stick or with the stick removed, has a shape that works particularly well with the present invention.

Specifically, the teething pacifier 20 comprises a first sidewall 26 constructed of a porous, permeable material such as terry cloth. The first sidewall 26 is typically rectangular in shape, and defines a perimeter edge 28. Similarly, a second sidewall 30, of like shape, is constructed of the same or similar porous material to define a perimeter edge 32. Accordingly, the second sidewall 30 forms a mirror image of the first sidewall 26. In this way, the first and second sidewalls 26, 30 can be aligned adjacently and sewn together with stitches along their respective perimeter edges 28, 32 to form a containment compartment 34 disposed between the first and second sidewalls 26, 30. As will be discussed more fully below, the stitches forming the containment compartment 34 in the present invention are hidden by turning inside-out, the teething pacifier 20 formed by initially sewing together the perimeter edges of the first and second sidewalls 26, 30.

Importantly, the sewing is discontinuous, i.e. stops to form an opening 36 into the containment compartment 34 for receiving the frozen liquid 22 therein. To maintain the frozen liquid 22 within the containment compartment 34, a closing or restricting means 38 is provided to close the opening 36. Additionally, a band 40, constructed to form a loop, is connected to at least one sidewall for tethering the first and second sidewalls 26-30, and accordingly the containment compartment 34 formed thereby, to an infant's arm 42.

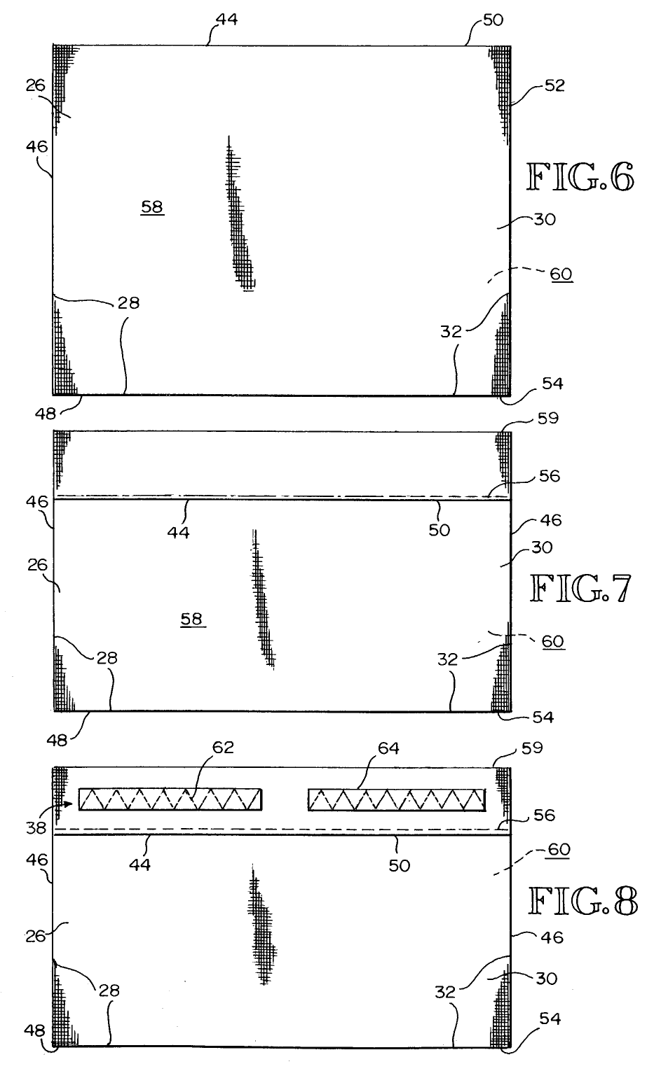

Considering now in more detail the structure of a teething pacifier 20 constructed in accordance with the present invention, each first and second sidewall 26 and 30 is similarly shaped and constructed of substantially rectangular porous terry cloth like material. It should be noted that any porous material that will allow liquid to pass through could be employed. In the present invention the sidewalls 26 and 30 are constructed from a single piece of homogenous material thus making the first and second sidewalls 26, 30 integrally interconnected, i.e., a single piece of cloth is folded in half to make the two sidewalls. This is best illustrated in FIGS. 6 through 12. FIG. 6 shows a plan view of a rectangular piece of permeable material where half of the material represents the first sidewall 26, and the other half represents the second sidewall 30. As will be discussed more fully below, the sidewalls 26, 30 extend from and share a common fold line 74. In addition, each sidewall comprises a plurality of substantially straight edges. First sidewall 26 comprises edges 44, 46 and 48, whereas second sidewall 30 comprises edges 50, 52 and 54. Further, as noted in the following, the first and second sidewalls 26 and 30 together form an interior surface 58, and an exterior surface 60. Accordingly, the interior surface 58 defines the containment compartment 34.

In the process of making a teething pacifier 20 in accordance with the present invention, edges 44 and 50 are folded over as shown in FIG. 7, and sewn continuously to a respective sidewall to form a stitch line 56 thereby creating a smooth hem 59. For example, edge 44 is sewn to first sidewall 26, and edge 50 is sewn to sidewall 30. Following this, a rectangular piece of hook material 62 is sewn to the first sidewall 26, and a rectangular piece of loop material 64 is sewn to the second sidewall 30 as illustrated in FIG. 8. The sewing of the hook and loop material could be along the edges thereof or in a criss-cross or zigzag pattern. Hook and loop fastening material, such as Velcro®, is typically employed in the present invention to restrict and fasten the opening 36 of the teething pacifier 20. However, it should be understood that many other types of fastening devices could be substituted including buttons, snaps, ties etc (not illustrated).

Also provided in the present invention is a band 40 which is provided to tether the teething pacifier 20 to an infant's arm or wrist. Typically, a band 40 is made from any suitable material including terry cloth and/or elastic fabric to form a long thin cord. Turning again to FIGS. 1 through 3, the present invention further comprises a band 40 having a snap type fastener 66. The snap type fastener 66 includes a post 68 and corresponding spaced-apart receiver hole structure 70 provided on the band 40 so that the same can be fastened to itself. In this way, a loop 72 is provided to extend around the infant's arm 42 thereby creating a tether to the infant 24. Although the construction of the band 40, in the present invention, is as described above, an alternate type of band, such as illustrated in FIG. 5, could be employed. For example, FIG. 5 illustrates a band 40 made from elastic to form an endless loop 73 that could be stretched over the wrist of an infant 24 thereby providing a tether.

In addition, construction of a teething pacifier 20 which includes a band 40, or like structure, is particularly suited for connection to a pacifier clip 77. Typically a pacifier clip 77 comprises a strap 79 that extends from a button protector 80. The button protector includes a clip fastener 81 that fastens the pacifier clip 77 to an article of clothing worn by the infant. The strap 79 also includes hook and loop fastener 83 to form a loop around the band 40.

Directing attention again to FIGS. 6 through 12, a further step in making a teething pacifier 20 includes positioning and folding the first and second sidewalls 26, 30 (FIGS. 10 and 11) along a fold line 74 which represents the point at which the sidewalls come together, i.e., where the sidewalls are integrally interconnected. Importantly, it should be understood that although the present invention includes integral interconnected sidewalls, a teething pacifier could be constructed of sidewalls that are not interconnected. For example, each sidewall could be a completely separate piece of material (not illustrated).

Turning again to FIG. 11, the first and second sidewalls 26 and 30 are folded together so that the exterior surface 60 is folded back upon itself. In this way, edges 46 and 52 are adjacently aligned and sewn together by stitch line 76, and edges 54 and 48 are adjacently aligned and sewn together by stitch line 78. It should be noted that edges 54 and 52 combine to form perimeter edge 32, and that edges 46 and 48 combine to form perimeter edge 28.

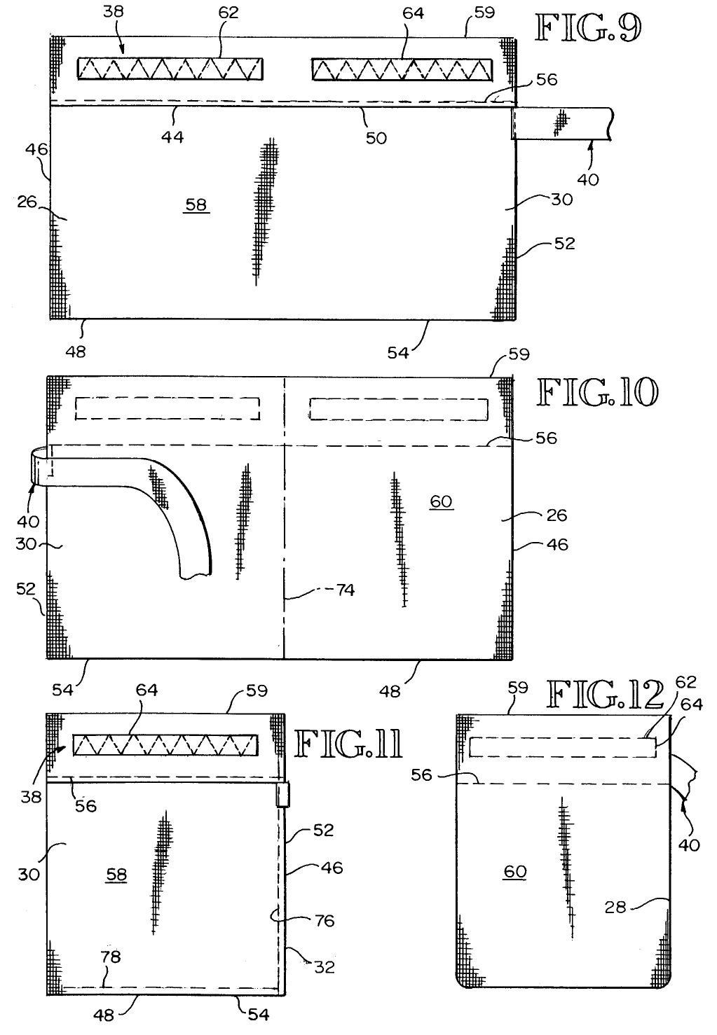

In addition, prior to sewing the edges together as noted above, the band 40, is positioned on the interior surface 58, adjacent edge 52 as illustrated in FIG. 9 and sewn to the interior surface 58. Then the band 40 is folded around edge 52 so that it is adjacent exterior surface 60 as illustrated in FIG. 10. With this configuration, after the edges are sewn together (FIG. 11), the sidewalls can be turned inside-out, as illustrated in FIG. 12 to hide stitch lines 76, 78 and to form the containment compartment 34 wherein the band 40 extends from the sidewalls as illustrated in FIG. 12. This is arranged as such to improve the appearance of the exterior surface 60 of the teething pacifier 20.

Accordingly, the step of turning inside-out the sidewalls as noted above, aligns the hook material 62 to contact the loop material 64. For this purpose, a frozen liquid 22 can be contained within the containment compartment 34. In addition, the band 40 is exposed as a tether for connection to the infant 24

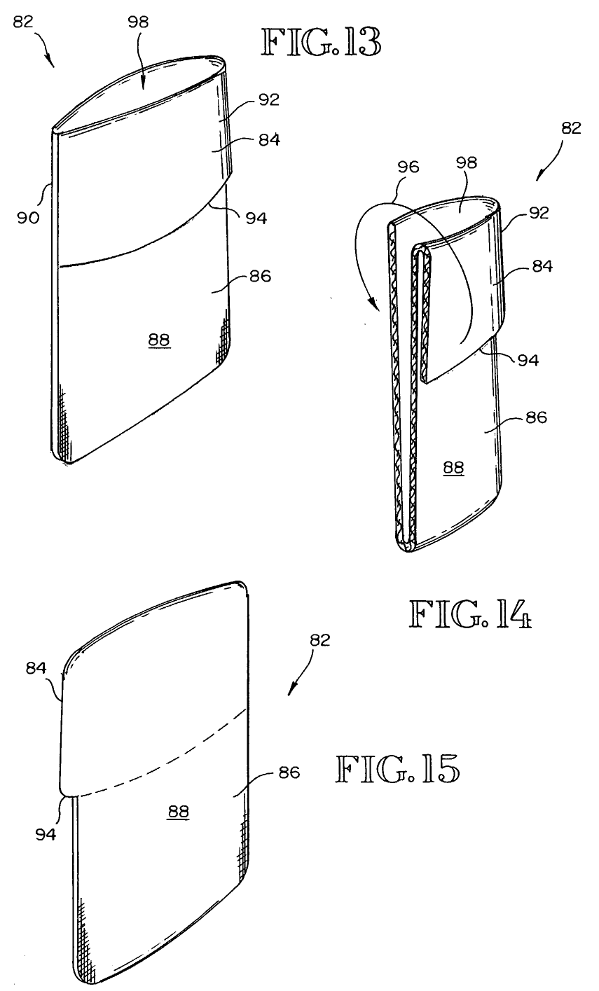

Directing attention to FIGS. 13, 14 and 15, an alternate embodiment is illustrated showing a teething pacifier 82 constructed as noted above, except for the following: A closure fold 84 is formed by the extension of sidewall 86, which is folded back adjacent the exterior surface 88. The closure fold 84 is attached, i.e., sewn along edges 90 and 92 thereby leaving edge 94 free to flip-over as indicated by arrow 96. Accordingly, the opening 98 can be closed by flipping-over the closure fold 84 which results in a configuration as illustrated in FIG. 15 where the opening is restricted by the closure fold 84.

Accordingly, the closure fold is disposed adjacent the opening over the exterior surface wherein this construction allows the closure fold to be movable from a first position, where the opening can receive frozen liquid, to a second position covering the opening to prevent the frozen liquid from escaping.

Having illustrated and described the principles of my invention in a preferred embodiment thereof, it should be readily apparent to those skilled in the art that the invention can be modified in arrangement and detail without departing from such principles. I claim all modifications coming within the spirit and scope of the accompanying claims.

What is claimed is:

1. A teething pacifier for receiving a volume of flavored frozen liquid which melts while therein to transmit a resulting cold melted liquid to an infant's mouth and gums while the infant is sucking on the teething pacifier, the teething pacifier comprising:
a first sidewall constructed of a porous permeable material to define a perimeter edge;
a second sidewall constructed of porous material, as a mirror image of the first sidewall to define a corresponding perimeter edge disposed for alignment adjacent to the perimeter edge of the first sidewall;
a containment compartment disposed between the first and second side walls formed by sewing together the first and second sidewalls along their respective aligned perimeter edges, wherein the sewing is discontinuous to form a single opening into the containment compartment for receiving the frozen liquid therein;
means for restricting the opening; and
a band connected to at least one sidewall for tethering the containment compartment to an infant's arm.

2. A teething pacifier as recited in claim 1 wherein the first and second sidewalls are integrally formed.

3. A teething pacifier as recited in claim 2 wherein hook material is attached to one sidewall adjacent the opening, and loop material is similarly attached to the opposing sidewall, adjacent the opening to provide means for restricting the opening by bringing the hook and loop material together after the frozen liquid is received into the compartment.

4. A teething pacifier as recited in claim 1 wherein hook material is attached to one sidewall adjacent the opening, and loop material is similarly attached to the opposing sidewall, adjacent the opening to provide means for restricting the opening by bringing the hook and loop material together after the frozen liquid is received into the compartment.

5. A teething pacifier as recited in claim 1 wherein the band comprises at least one snap fastener having a post and a corresponding spaced-apart receiver hole structure wherein the band forms a loop when the post is received into the receiver hole.

6. A teething pacifier as recited in claim 1 wherein a pacifier clip is removably attached to the band of the teething pacifier.

7. A method of making a teething pacifier for receiving a volume of flavored frozen liquid which melts while therein to transmit a resulting cold melted liquid to an infant who is sucking on the teething pacifier, the method comprising the steps:
providing a substantially rectangular piece of porous permeable material that defines a first sidewall and a second sidewall wherein the first sidewall defines a perimeter edge, and the second sidewall defines a corresponding perimeter edge;
creating a hem by folding a portion of the material over and stitching the fold;
sewing the first and second sidewall together along their corresponding perimeter edges to form an interior surface and an exterior surface; and
turning the material inside-out to expose the exterior surface, wherein the interior surface defines a containment compartment and an opening thereto for receiving a frozen liquid into the containment compartment.

8. A method of making a teething pacifier as recited in claim 7 further comprising the step of sewing a band to the interior surface prior to sewing the first and second sidewalls together so that after turning the material inside-out, the exterior surface is exposed, and the band extends outside the exterior surface.

9. A method of making a teething pacifier as recited in claim 7 further comprising the step of sewing a fastening means adjacent the hem so that as the exterior surface is exposed, the fastening means can be fastened to restrict the opening of the containment compartment.

10. A method of making a teething pacifier as recited in claim 9 further comprising the step of sewing a band to the interior surface prior to sewing the first and second sidewalls together so that after turning the material inside-out, the exterior surface is exposed, and the band extends outside the exterior surface.

11. A teething pacifier for receiving a volume of flavored frozen liquid which melts while therein to transmit a resulting cold melted liquid to an infant's mouth and gums while the infant is sucking on the teething pacifier, the teething pacifier comprising:
a first sidewall constructed of a porous permeable material to define a perimeter edge;
a second sidewall constructed of porous material, as a mirror image of the first sidewall to define a corresponding perimeter edge disposed for alignment adjacent to the perimeter edge of the first sidewall;
a containment compartment disposed between the first and second side walls formed by sewing together the first and second sidewalls along their respective aligned perimeter edges, wherein the sewing is discontinuous to form a single opening into the containment compartment for receiving the frozen liquid therein;
an exterior surface defined by the first and second sidewalls; and
a closure fold disposed adjacent the opening over a portion of the exterior surface wherein the closure fold is movable from a first position, where the opening can receive frozen liquid, to a second position covering the opening to prevent the frozen liquid from escaping.

12. A teething pacifier as recited in claim 11 wherein the closure fold is formed integrally with a portion of one of the sidewalls.

13. A teething pacifier as recited in claim 11 wherein a band is connected to at least one sidewall for tethering the teething pacifier to an infant's arm.

14. A teething pacifier as recited in claim 11 wherein the first and second sidewalls are integrally formed.

15. A teething pacifier as recited in claim 14 wherein hook material is attached to one sidewall adjacent the opening, and loop material is similarly attached to the opposing sidewall, adjacent the opening to provide means for restricting the opening by bringing the hook and loop material together after the frozen liquid is received into the compartment.

16. A teething pacifier as recited in claim 11 wherein hook material is attached to one sidewall adjacent the opening, and loop material is similarly attached to the opposing sidewall, adjacent the opening to provide means for restricting the opening by bringing the hook and loop material together after the frozen liquid is received into the compartment.

17. A teething pacifier as recited in claim 13 wherein the band comprises at least one snap fastener having a post and a corresponding spaced-apart receiver hole structure wherein the band forms a loop when the post is received into the receiver hole.

18. A teething pacifier as recited in claim 17 wherein a pacifier clip is removably attached to the band of the teething pacifier.
